(19) United States
(12) Patent Application Publication
(10) Pub. No.: US 2010/0053175 A1
(43) Pub. Date: Mar. 4, 2010

(54) Wireless Display for Compensation or Cause

(76) Inventor: Bedros Tashjian, Studio City, CA (US)

Correspondence Address: BEDROS PETER TASHJIAN, 10947 BLOOMFIELD ST. #220, STUDIO CITY, CA, 91602, US

(21) Appl. No.: 12/545,866

(22) Filed: Aug. 24, 2009

Related U.S. Application Data
(60) Provisional application No. 61/092,059, filed on Aug. 27, 2008.

(51) Int. Cl. G06T 1/00

(52) U.S. Cl. 345/501

(57) ABSTRACT

Embodiment of wireless display devices that may display graphics, advertisements, text and data of any type controlled remotely or by embedded instructions that are embedded, affixed or weaved into clothing and other belongings of a person. Businesses can partner with people willing to wear said device for compensation. The said display can be tracked by GPS and compensation models and tiers created based on distance, location and the duration the display displays advertisement data for said businesses. In addition, said display may optionally transmit audio and can optionally contain a mechanism for input. This can be applied to both commercial and personal uses. Other embodiments are described and shown.

### CROSS-REFERENCE TO RELATED APPLICATIONS

This application claims the benefit of provisional patent application No. 61/092,059, filed 2008 Aug. 27 by the present inventor.

### FEDERALLY SPONSORED RESEARCH OR DEVELOPMENT

Not Applicable

### SEQUENCE LISTING, A TABLE, OR A COMPUTER PROGRAM LISTING COMPACT DISK APPENDIX

Not Applicable

### BACKGROUND OF THE INVENTION

This embodiment generally relates to the need for communication of human beings which is as fundamental as the need for food, water and air. Technical innovations have created and continue to create a variety of delivery platforms and mechanisms to help facilitate novel means of communication and self expression, for example commercial websites, personal websites, social networks, web logs also known as blogs, text messaging, reading devices for ebooks and communicating by the use of mobile phones, smart phones and personal computers. These tools have joined more traditional platforms and methods of disseminating and sharing information for both commercial and personal uses such as television, news papers, magazines, billboards, and even as signs on automobiles. This embodiment provides businesses a means of advertising products, strengthen the brand of a business by providing novel means of using technologies to create a novel data delivery methods to consumers. Businesses can greatly profit by extending the reach of advertisement. Data sent by businesses can be displayed by means of a display on person's clothing and belongings.

As technologies advance, we must find novel ways to apply them in order to truly benefit from the advancements. Never before has humanity had the type of technologies within their reach in order to facilitate the dissemination of dynamic information, to diverse targets and never before reached destinations. Being able to instantly distribute news especially to hard to reach areas has the potential to save lives at times, for example by means of “Amber alerts”.

This embodiment clearly shows how said display can be utilized on a person's clothing or belongings to display commercial or any other data in order to advance commercial messaging needs of businesses. Said display and its content can be tracked by the use of GPS by businesses and based on but not limited to location, distance and time the display is displayed and venue the person attends can be compensated for by businesses hoping to extend their advertisement messaging to help increase profit by means of such advertisement on said display.

Though this embodiment has unlimited commercial potential for businesses, one of the most important benefits is that it empowers individuals to communicate and share their thoughts like never before. This embodiment can also bring forth never before thought of opportunities and may foster the start of new and revolutionary outcomes.

### BACKGROUND OF THE INVENTION

### Prior Art

While dynamic, digital displays have been used in various ways and on different devices such as televisions, computer monitors, mobile phones, smart phones, laptops or netbooks, watches, car dashboards and other devices they have not successfully been extended to use on people or pets, clothing and accessories, exteriors of vehicles and other uses. This embodiment drastically extends the use of technologies in ways they have not been prior to this embodiment.

Several types of uses for displays attached to, embedded in or weaved into garments have been proposed—for example, in a U.S. patent application 2006/0028430 (2006), and U.S. patents U.S. Pat. No. 5,912,653 (1999), U.S. Pat. No. 6,895,261 (2005), U.S. Pat. No. 5,722,192 (1998), U.S. Pat. No. 4,709,307 (1987), U.S. Pat. No. 4,823,240 (1989), U.S. Pat. No. 6,080,690 (2000), U.S. Pat. No. 6,140,981 (2000), U.S. Pat. No. 6,393,745 (2002), U.S. Pat. No. 6,727,197 (2004), U.S. Pat. No. 6,729,025 (2004), U.S. Pat. No. 6,843,012 (2005), U.S. Pat. No. 7,133,002 (2006). Though the listed Prior Arts mention or refer to displays, they do not contain the specifications, purpose, application or spirit of this embodiment.

On a website called “How Stuff Works”, one can find the following articles published, “How Computer Clothing Works” and “How Fabric Displays Work”, mention the use of displays in clothing. In the article, “How Fabric Displays Work”, an LCD display was mounted on some models which displayed advertisement per the article. On the website “Wired” an article was published called, “Ready to Ware: Clothes That Look Hip and Track Your Vital Signs, Too”. On the website “Bankrate”, an article was published called, “Make money by simply driving your car”. This involves a non digital, static advertisement plastered to the car. An advertisement firm can track the movement of the vehicle by the use of a GPS system. In an article on Financial Times on the web, an article titled, “CBS and Pepsi bring video ads to printed page”. The article did not provide specifics. None of the prior arts listed above address the embodiment being described in this document in its entirety.

### BRIEF SUMMARY OF THE INVENTION

The present embodiment is the use of a display or displays affixed to, part of, or embedded in articles of clothing and or accessories on a person, vehicles and/or any other objects this embodiment can be extended to. The display could be controlled remotely and/or by embedded preprogrammed instructions to disseminate both commercial and other data.

Use of displays that can show graphics, advertisements, text of any kind controlled remotely or by embedded instructions. In addition, it may transmit audio and will optionally contain a mechanism for input. The device will be affixed to any article of clothing or accessories on a person. The display can be controlled by the wearer and/or can be controlled remotely by other entities such as businesses and technologies. Businesses can remotely transmit advertisements and messages to the display device and thereby have the ability to penetrate spaces not easily penetrated and/or reached prior to this embodiment by the use of portable display devices. The device can accept transmission of any type from any source both remote or local.

This will make possible the dissemination of information to any location a person may roam. The transmission of information would be used for many purposes including but not limited to commercial, personal and propaganda of any kind.

This advances the use and application of technology in enabling new and novel means of communicating and disseminating information. This relates to the application of a display that may include input, output and storage capabilities in any combination or as standalone components affixed to or embedded in articles of clothing and accessories on a person or belongings of said person.

### BRIEF DESCRIPTION OF THE SEVERAL VIEWS OF THE DRAWING

The features and objects of the present embodiment will become more apparent and understood by the following detailed description when read with reference to the accompanying drawings, wherein:

FIG. 1 shows a display device affixed or embedded to a backpack and clothing worn on a person

FIG. 2 shows a display device on a shirt that is receiving transmission from various sources

FIG. 3 shows a display device on a pet dog affixed to an article of clothing

FIG. 4 shows blocks of city space where data is transmitted to a display device affixed to or embedded to a messenger bag carried by a person

FIG. 5 shows a person with a display which can interface with data sources, means of data transmission and data storage

FIG. 6 shows a display on a person and shows various components this embodiment may utilize

FIG. 7 shows data being exchanged between displays on various sources and a business that may ultimately utilize this embodiment to increase company profit

FIG. 8 shows an embodiment that is extended to an automobile

FIG. 9 shows a display, a shopping strip, a terminal the display can exchange data with

### DETAILED DESCRIPTION OF THE INVENTION

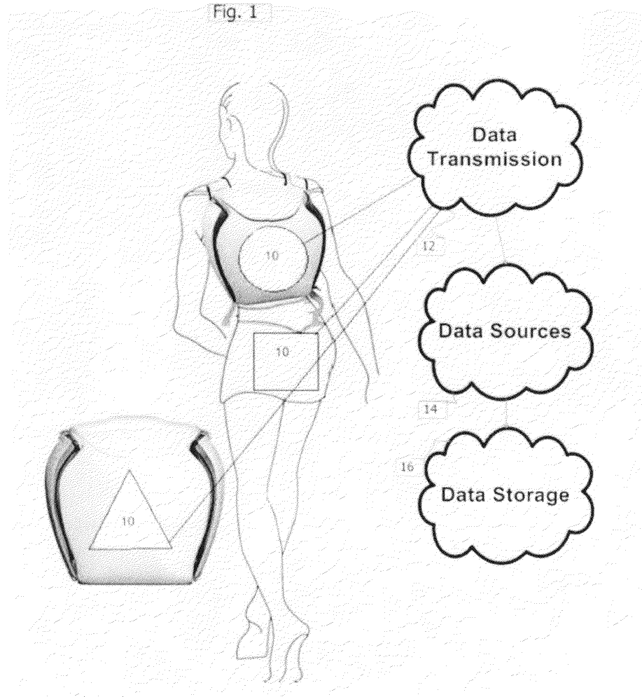

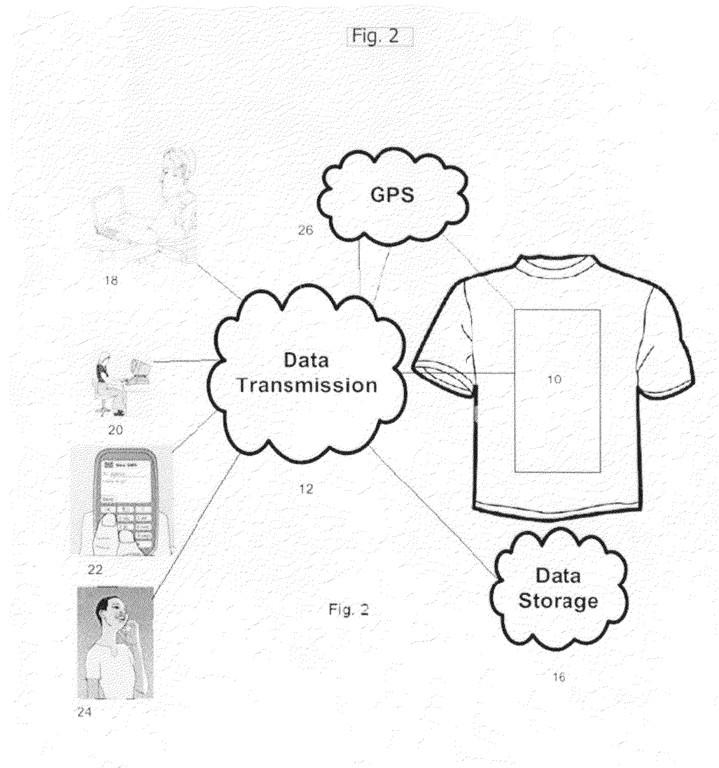

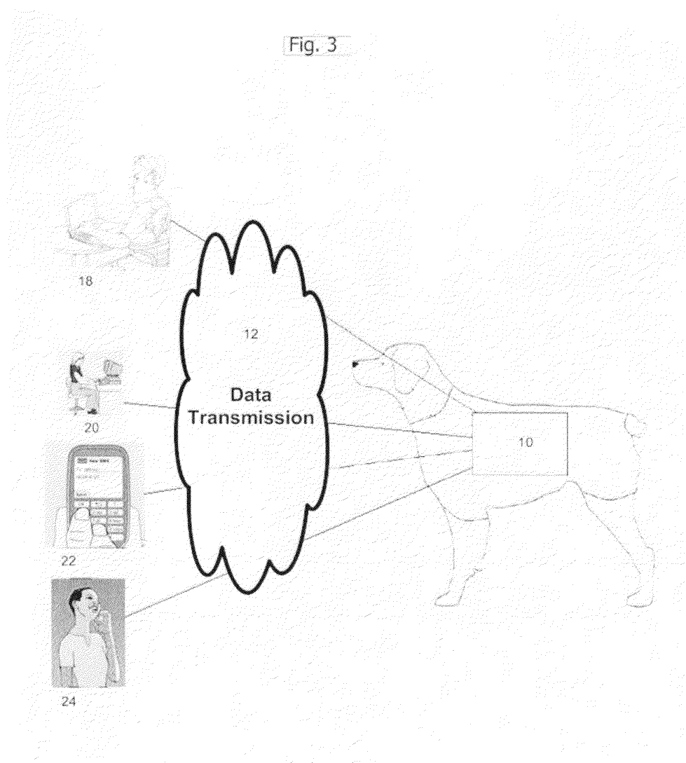

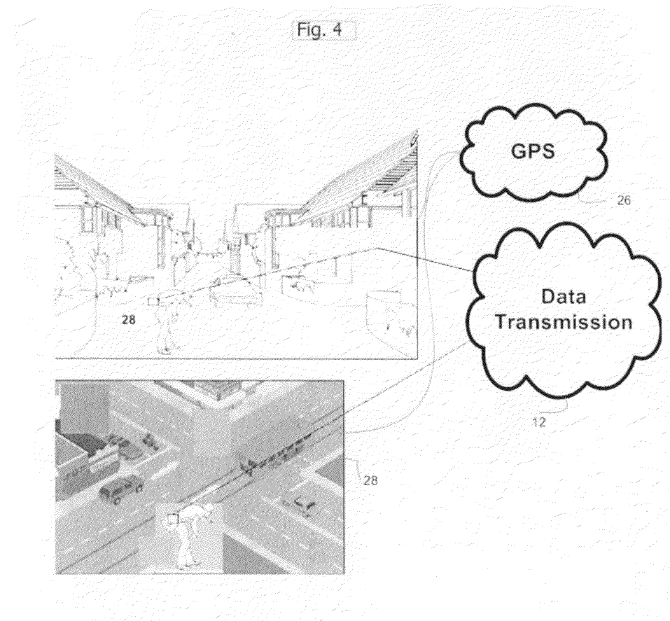

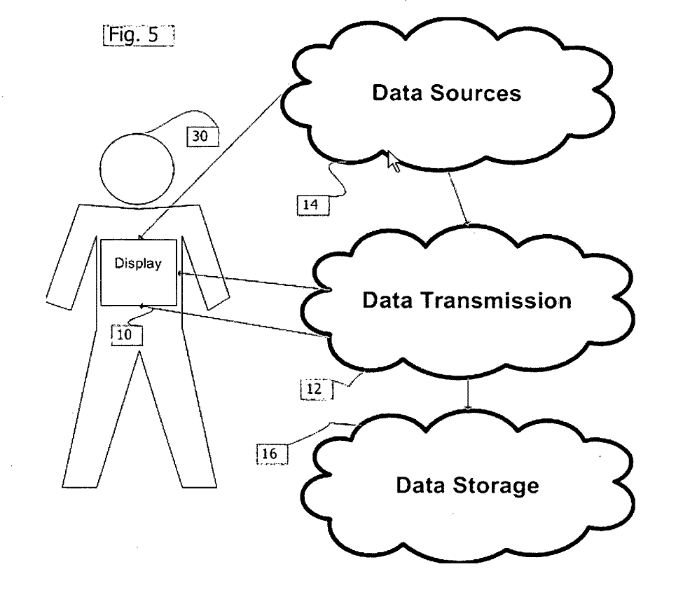

FIG. 1 shows the display device affixed, attached or embedded to a backpack 10 worn by a person. The display device is wireless and is receiving transmission from data sources 14. The display device can have various shapes for example but not limited to square 10, triangle 10 circular 10, any abstract shape or free form such as alphabetical letters and markings. FIG. 2 shows various data sources such as laptop 18, personal computer 20, data entered by a handheld device 22, speech captured by a mobile phone 24 that can initiate and/or transmit data to the display 10 by means of various transmission methods 12. For example by speaking into a mobile device, the spoken words can be transposed to text by services provided by websites including but not limited to Jott.com where speech recognition software transposes spoken words to text. This text can then be transmitted through data delivery mechanisms 12 including but not limited to transmitters-receivers utilizing transponders and satellites to the display devices. Both private and commercial entities can utilize this mechanism to send data to the display device. FIG. 3 shows this device affixed to a pet dog directly or affixed to an article of clothing or accessory 10 which can receive data directly through various means including 18, 20, 22, 24 but not limited to the items listed. FIG. 5 shows data being sent by data sources 14. The data sources will feed, for example streaming media such as but not limited to videos, graphics, pictures, text and audio including various multi-media file formats. FIG. 4 shows blocks of streets 28, geographical areas that can be located by the use of global positioning system 26 to keep record of location and movement of the display. Businesses may purchase designated spaces to ensure only their information is disseminated in those specific areas marked by latitude and longitude coordinates.

FIG. 1 shows a display device on a person which can be controlled remotely by transmission from data sources 14 on both open and/or encrypted secure transmission by utilizing a unique identifier or key and/or by embedded preprogrammed instructions within the device. The display device 10 can be of varying sizes depending on what article clothing or accessories it is affixed to or embedded in. For example, it can be affixed to or embedded in clothing articles such as shirts, pants, including footwear of any type, containers such as bags and backpacks but not limited to these articles. The device can be of any width, length and height.

FIG. 2 shows a shirt with a display device 10 on it. Each individual can decide the available-for-advertisement surface on articles they wear or carry on their person. They can also be given or purchase articles with predefined available-for-advertisement surfaces.

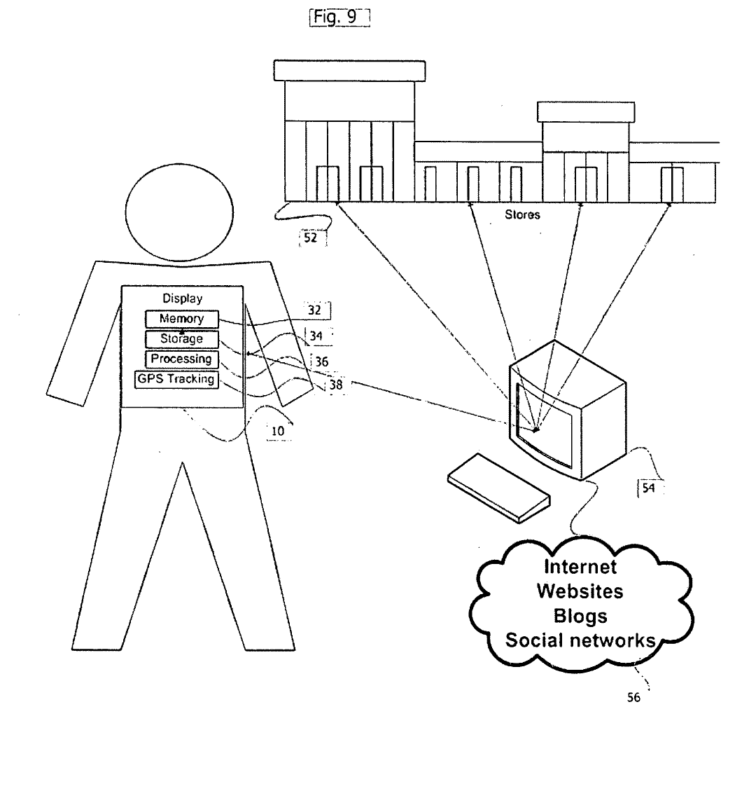

Various pricing scales can be utilized to award the person for the available-for-advertisement surfaces provided. Compensation whether monetary or in any other form can be based on many factors. For example the moving person can be tracked by the use of GPS 26 but not limited to GPS. This information can be used to calculate the award based on the geographical space the person covers while being in possession of the display device combined or not combined with the length of time the display device was active with a particular set of data whether textual, graphical or audio but not limited to these data formats. A unique identifier can be shown on the display to help track the success of the message being displayed. The award can be based on the number of leads or hits received using a unique identifier. A series of source code and campaign identifiers in the data not limited to numeric values either encrypted or not encrypted can be implemented and captured to calculate the award and measure the success of the message. Any geographical location whether it's a block of streets shown in FIG. 4 in a city or stores, shopping centers 52 or shopping strips as shown on FIG. 9.

The display device can also display a value other than a phone number, for example a unique identifier or address associated with the display or person in possession of the display device. This information can then be captured by interested parties which in turn will be used to calculate the number of contacts initiated by the message on a particular instance of the display device on the person.

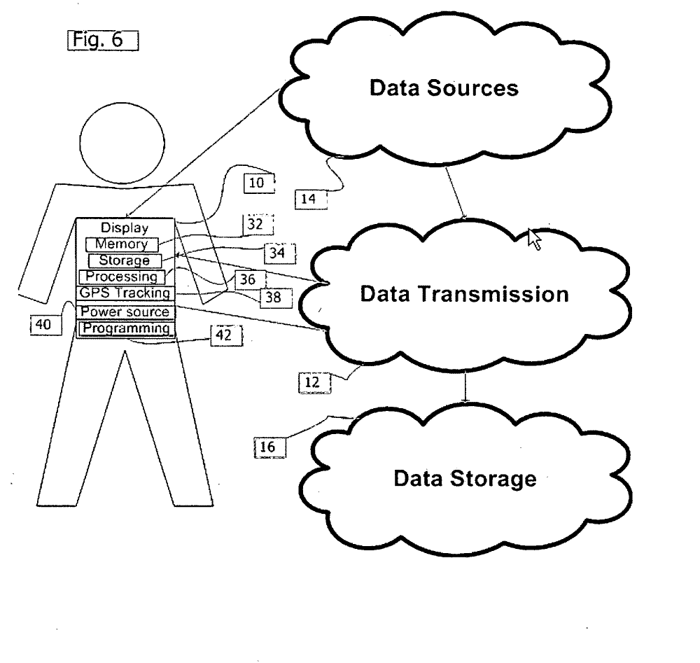

As shown on FIG. 6 said display 10 can contain various components such as but not limited to computer memory 32, storage 34, Processor 36, GPS tracking component 38, programming 42 and a power source 40 in any combination. Said display may include just one or more of the aforementioned components and in any combination.

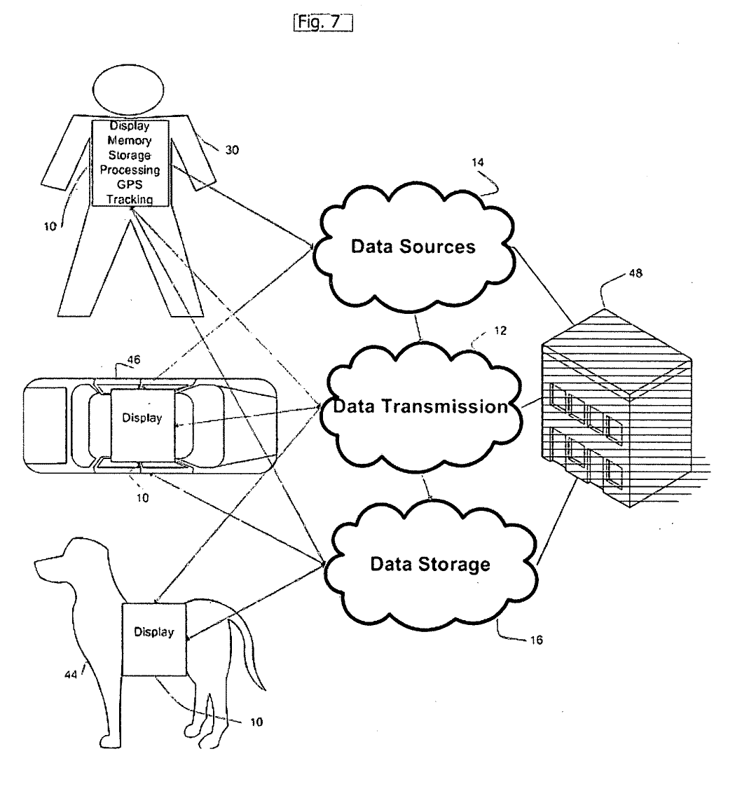

As shown in FIG. 7 said displays on a person 30, an automobile 46 and a dog 44 are transmitted data from data sources 14 through data transmission 12 that originate from data storage 104. Any and all of these technologies may be bidirectional. A business 48 may utilize this embodiment to extend its advertisement reach and increase its customer base.

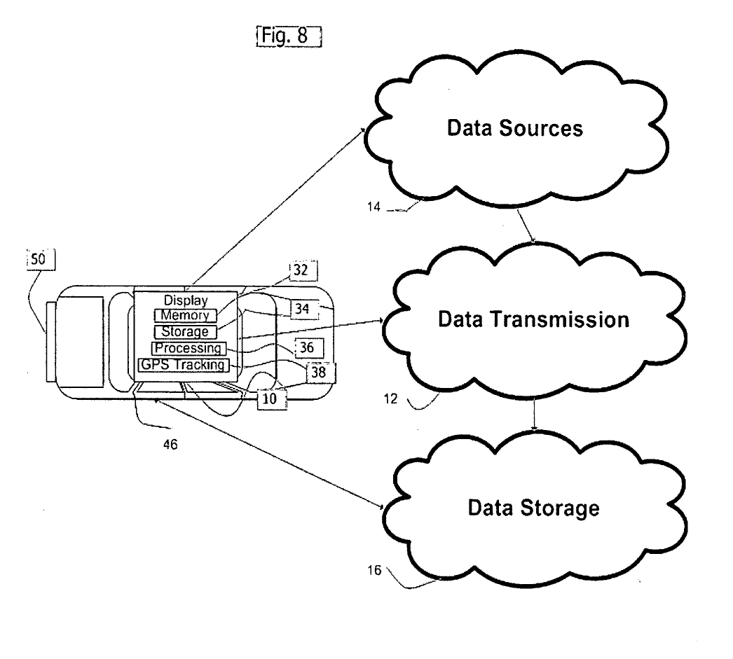

As shown in FIG. 8 said display can be extended to said automobile 46 and a display can be affixed to said automobile's bumper 50, rear or front.

As shown in FIG. 9 a person with said display can navigate to a website, register, login and choose graphics or advertisement to download to said display device. Stores can set up terminals that consumers with said displays can interface with to download any type of data the stores choose. Persons may subscribe to specific downloads in order to pick and choose the data that may be downloaded to said device. A person may choose to keep the device open to random wireless transmissions that wireless hotspots may transmit.

This embodiment can make possible tracking of the person with said display by the use of GPS and based on distance covered or special venue or location the person with the display visits, various compensatory models may be created to award the person with said display. In addition to having the display in any location, attendance of the person with said display to various special venues such as but not limited to music concerts, sporting events, political gatherings can be used to create various compensatory models.

I claim:

1. A method of displaying data on a person that can be monitored and tracked by technology comprising:
(a) a display
(b) memory
(c) data transmission means wired or wireless
(d) data input mechanism for delivering said data to processing and storage components
(e) tracking and monitoring mechanisms
whereby said display will display said data on a person received by means of said data transmission by means of said input and said display.

2. The method of claim 1 wherein displaying data on a person can be tracked, saved and stored by technology comprising:
(a) a display
(b) memory which is able to store computer data
(c) data transmission means wired or wireless
(d) data input mechanism for delivering said data to processing and storage components
(e) tracking and monitoring mechanisms
(f) data save mechanism
(g) data storage
(h) power source

3. A method of using said wireless display attached, affixed to or embedded in articles of clothing and accessories on a person which can be controlled remotely and by embedded preprogrammed instructions and data for the display of information for both commercial and personal use.

4. A method of using said wireless display device attached, affixed to or embedded in articles of clothing and accessories on a person which can be controlled remotely and by embedded preprogrammed instructions and data for the display of information for both commercial and personal use that can be saved and stored.

5. The method of claim 4 can be extended to a subscription service. A person can sign up to a program and pick and choose the advertisement they want to display on the display embedded or affixed to any of their belongings by means of a website. They can be given a unique identifier and the company for whom they advertise may track the advertisement being displayed by associating the advertisement to the person by means of said unique identifier.

6. A method of using said wireless display device affixed to or embedded in articles of clothing and accessories on a person that can be tracked by the use of GPS, which can be controlled remotely and by embedded preprogrammed instructions and data for the display of information for both commercial and personal use that can be saved and stored and person with display compensated.

7. The method of claim 5 can be leveraged to make possible the commoditization of space on a person for advertisement purposes

8. The method of claim 5 can be leveraged to make possible the commoditization of space on a person's belongings for advertisement purposes

9. The method of claim 5 can be tracked by GPS (Global Positioning System) in order to track the geographical location and distance covered by the display which may be affixed, part of or embedded in articles of clothing and accessories on a person

10. The method of claim 5 can be used to track the distance covered and location of the wireless display, various tiers of compensation may be awarded to the person the display is attached to.

11. The method of claim 5 can accept data as input from blogs, social networks and or any other digital form

12. The method of claim 5 can also be affixed to, part of or embedded to the exterior of automobiles for the same purposes and benefits applied to persons a display is affixed to, part of or embedded in the clothing of.

13. The method of claim 5 can apply to automobile bumpers by replacing static bumper stickers with digital ones with rotating message and said GPS embedded in sticker or automobile.

14. The method of claim 5 can apply to a display that can also be affixed to, part of or embedded to clothing on pets for the same purposes and benefits applied to persons a display is affixed to, part of or embedded in the clothing of.

15. A method businesses can utilize to extend the reach of advertisements in order to increase profit for said business by utilizing this embodiment.

16. Businesses can create websites and can add computer terminals to stores that consumers can use to register, login and transfer data to said display in their possession for compensation or a trade or for free. The data transfer may or may not require registration and login.

17. The method of claim 16 can make possible tracking of the person with said display by the use of GPS and based on distance covered or special venue or location the person with the display visits, various compensatory models may be created to award the person with said display.
